(19) United States
(12) Patent Application Publication
(10) Pub. No.: US 2006/0204754 A1
(43) Pub. Date: Sep. 14, 2006

(54) Metal nano-particles coated with silicon oxide and manufacturing method thereof

(75) Inventor: Dae Sam Kang, Ansan (KR)

Correspondence Address: LEYDIG VOIT & MAYER, LTD, 700 THIRTEENTH ST. NW, SUITE 300, WASHINGTON, DC, 20005-3960, US

(73) Assignee: Mijitech Co. Ltd, Sangrok-Gu (KR)

(21) Appl. No.: 10/546,456

(22) PCT Filed: Mar. 6, 2004
(86) PCT No.: PCT/KR04/00474

§ 371 Date: Dec. 28, 2005

(30) Foreign Application Priority Data
Mar. 8, 2003 (KR) 10-2003-0014578

(51) Int. Cl. B05D 7/00; B32B 5/16

(52) U.S. Cl. 428/379; 427/212; 428/404

(57) ABSTRACT

Disclosed herein is a metal nanoparticle whose surface is coated with a silicon oxide. The silicon oxide is obtained from a silicon compound or a derivative thereof as a precursor and has a particle diameter of a few angstroms (A). Further disclosed is a method for manufacturing metal nanoparticles. The method comprises the steps of a) mixing metal ions, a solvent and an additive required for forming metal complex ions, b) adding a silicon compound or a derivative thereof as a precursor for forming silicon oxides, to the mixture of step a) to coat the surface of the metal ions, and c) adding a reducing agent to the mixture of step b) to reduce the metal ions. If necessary, the method further comprises the step of d) lyophilizing the resulting product of step c), i.e. metal nanoparticles. Since the surface of the metal nanoparticle of the present invention is coated with a silicon oxide, the metal nanoparticle is stabilized. In addition, the metal nanoparticle retains electromagnetic properties inherent to the metal and can be easily manufactured in an economical manner.

### TECHNICAL FIELD

The present invention relates to a metal nanoparticle whose surface is coated with a silicon oxide, and a method for manufacturing the metal nanoparticle. More particularly, the present invention relates to a stabilized metal nanoparticle comprising a nanosized metal and a silicon oxide surrounding the nanosized metal wherein the silicon oxide is obtained from a silicon compound or a derivative thereof as a precursor and has a particle diameter of a few angstroms (Å), and a method for manufacturing the metal nanoparticle.

### BACKGROUND ART

Nanoparticles refer to particles having a diameter on the order of nanometer scale (1˜100 nm). Materials within this diameter range are in intermediate states between bulky metals and molecular metals. Despite the same chemical composition, these materials exhibit optical and electromagnetic properties different from bulky states due to their drastically increased specific surface area and quantum effects.

In this regard, there has been much interest in metal nanoparticles in terms of catalytic, electromagnetic, optical and medical applicability [See, (a) Matijevic, E. Curr. Opin. Coll. Interface Sci. 1996, 1, 176; (b) Schmid, G. Chem. Rev. 1992, 92, 1709; and (c) Murray, C. B.; Kagan, C. R. Bawendi, M. G. Science 1995, 270, 1335].

In particular, uniform orientation and layering of the nanoparticles by dispersion, targeting and pasting processes may largely contribute to creation of new materials only depending on the particle diameter without changing the chemical compositions, and further the adjustment of the particle diameter and order of orientation of the nanoparticles enables the control of the optical and electromagnetic properties. In industrially advanced countries, nanotechnology has drawn attention as a next generation technology over the past several years, and studies thereon as a national task have been actively undertaken [See, for example, (a) Matijevic, E. Curr. Opin. Coll. Interface Sci. 1996, 1, 176; (b) Schmid, G. Chem. Rev. 1992, 92, 1709; and (c) Murray, C. B.; Kagan, C. R. Bawendi, M. G. Science 1995, 270, 1335].

One of the most important tasks to be accomplished in order to practically use the potential applicability of nanoparticles is the synthesis of nanoparticles having a uniform size [See, e.g., Feldheim, D. L.; Keating, C. D. Chem. Soc. Rev. 1998, 27, 1].

Synthetic methods of metal nanoparticles known hitherto include a gas phase method wherein metal nanoparticles are synthesized at a high voltage in vacuo and a liquid phase method wherein metal nanoparticles are synthesized using an organic solvent and a polymer or a block copolymer. The gas phase method involves considerable manufacturing costs and is disadvantageous in terms of poor productivity and workability. In contrast, since the liquid phase method has advantages of easy manufacture, good productivity and superior workability, and necessitates relatively low manufacturing costs, it is predominantly used to manufacture metal nanoparticles. A representative example of the liquid phase method is a Sol-Gel process.

There have been a number of reports on the synthesis of metal nanoparticles such as gold, silver, platinum, palladium, ruthenium, iron, copper, cobalt, cadmium, nickel, silicon nanoparticles and the like.

However, these metal nanoparticles are unstable and agglomerate with the passage of time, eventually losing their nanoparticle characteristics. Thus, a method for preventing the agglomeration of nanoparticles and a method for preventing the surface of nanoparticles from being oxidized are needed to synthesize stable nanoparticles even in a solution state and a dry state.

In liquid phase methods previously reported in the art, various organic salts, inorganic salts and polymers have been used to prevent the agglomeration of nanoparticles. The syntheses of metal nanoparticles highly soluble and stable in organic solvents using a small-sized linear organic molecular compound or a silane coupling agent contained in a compound, have been recently reported [See, e.g., (a) Brust, M.; Walker, M.; Betheell, D.; Schffrin, D. J.; Whyman, R. J. Chem. Commun., 1994, 802; (b) Brust, M.; Fink, J. Bethell, D.; Schiffrin, D. J.; Kiely, D. J. Chem. Commun., 1995, 1655; and (c) University of Utrecht, Padualaan, 8,3584 CH Utrecht. Langmire, 1997, 13,3921-3926. The Nethlands].

In the case of metal nanoparticles synthesized by introducing the linear organic molecular compound into the surface of the metal, the metal nanoparticles can react like common organic compounds due to the characteristics of the organic molecular compound and can be separated from the reacted materials, but have problems that the size distribution of the nanoparticles cannot be easily controlled, and the agglomeration of the nanoparticles and bonding with an electrically nonconductive compound may take place upon drying, thus causing deterioration of electromagnetic properties inherent to the metal.

### DISCLOSURE OF THE INVENTION

Therefore, the present invention has been made in view of the above problems, and it is an object of the present invention to provide a surface-stabilized metal nanoparticle comprising a nanosized metal and a silicon oxide surrounding the nanosized metal wherein the silicon oxide is obtained from a silicon compound or a derivative thereof as a precursor and has a particle diameter of a few angstroms (Å). The metal nanoparticle is stable under ambient conditions and UV light and retains inherent electromagnetic properties of the metal.

It is another object of the present invention to provide a method for synthesizing the metal nanoparticle.

In order to accomplish the objects of the present invention, there is provided a stabilized metal nanoparticle whose surface is coated with a silicon oxide wherein the silicon oxide is obtained from any one of silicon compounds S-1-S-4 represented by Formula 1 below:

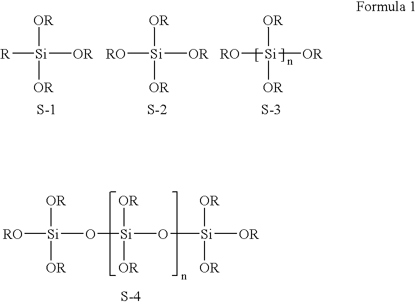

wherein

R is selected from hydrogen, C_{1˜20} alkyl, C_{6˜24} aryl, C_{1˜20} alkylated hydroxyl, C_{1˜20} alkyoxy, C_{1˜20} alkenyl, vinyl, acryl and amino groups; and n is an integer of from 1 to 1,000,

or a derivative thereof as a precursor.

Preferred silicon compounds include those wherein R is a C_{1˜5} alkyl or an alkoxy group, and n is an integer of from 1 to 100.

Metals usable to synthesize the metal nanoparticle include gold, silver, platinum, palladium, ruthenium, iron, copper, cobalt, nickel, silicon and the like according to the intended application, and can be preferably selected from the group consisting of gold, silver, platinum, palladium and ruthenium.

Reference diagram 1 below shows the structures of the surface-stabilized metal nanoparticle:

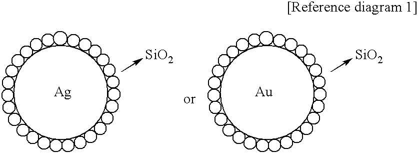

Although the silver and the gold nanoparticles are explained as depicted in Reference diagram 1 for illustrative purposes, it will be appreciated that numerous metal nanoparticles are possible, e.g., platinum, palladium, ruthenium, iron, copper, cobalt, nickel and silicon nanoparticles. Among them, gold, silver, platinum, palladium and ruthenium nanoparticles are preferred. These metal nanoparticles have the structures depicted in Reference diagram 1.

In order to accomplish the objects of the present invention, there is provided a method for manufacturing stabilized metal nanoparticles whose surfaces are coated with a silicon oxide, comprising the steps of:

a) mixing metal ions, a solvent and an additive required for forming metal complex ions;

b) adding any one of silicon compounds S-1˜S-4 of Formula 1 above or a derivative thereof as a precursor for forming a silicon oxide, to the mixture of step a) to coat the surface of the metal ions, the silicon oxide having a particle diameter of a few angstroms (Å); and

c) adding a reducing agent to the mixture of step b) to reduce the metal ions.

If necessary, the method of the present invention further comprises the step of d) lyophilizing the resulting product of step c), i.e. metal nanoparticles.

Hereinafter, the method for manufacturing metal nanoparticles will be explained in more detail.

In order to stabilize the surface of a metal nanoparticle, any one of silicon compounds S-1˜S-4 of Formula 1 or a derivativs thereof used as a precursor is hydrolyzed. Depending on the hydrolysis conditions including temperature, pH, the kind of solvents and the kind of additives, the silicon oxide may be controlled to a few angstroms (Å) in diameter and a spherical shape. In addition, upon reduction of the metal ions into the corresponding metal, the particle diameter and the shape of the metal are controlled by a reduction rate determined according to various factors such as the kind of solvents, pH, temperature and the like. The method of the present invention is characterized in that the size and the size distribution of the final metal nanoparticles are controlled by the hydrolysis and reduction effects.

In step a), the metal ions are obtained by dissolving the corresponding metal in an acid. At this step, the acid is selected from the group consisting of aqua regia (a mixture of 25% nitric acid (HNO₃) and 75% hydrochloric acid (HCl) (v/v)), nitric acid, hydrochloric acid and sulfuric acid. Gold and platinum are preferably dissolved in aqua regia, and the other metals are dissolved in an acid selected from nitric acid, hydrochloric acid and sulfuric acid to form the respective metal ions.

In step a), the metal ions are mixed with a solvent and an additive. This mixing enables control of the particle diameter of the metal ions to a few nanometers (nm). As the solvent, a mixture of an alcohol, a glycol and water is preferably used. The additive is preferably selected from the group consisting of ammonia water, β-alanine and triethanolamine. The additive acts to form metal complex ions and prevents drastic particle growth due to rapid reduction of the metal ions into the respective metal.

In step b), a silicon oxide is obtained from any one of the silicon compounds S-1˜S-4 of Formula 1 or a derivative thereof. The silicon oxide thus obtained acts to coat the surface of the metal ions. After the silicon compound or a derivative thereof is added to the mixture obtained from step a), it is hydrolyzed. Depending on the hydrolysis conditions including temperature, pH, the kind of the solvent and the kind of the additive, the silicon oxide may be a few angstroms (Å) in diameter and have a spherical shape. The hydrolysis is carried out at a pH of 4˜14 and a temperature between −70° C. and 100° C.

In step c), a reducing agent is added to reduce the metal ions. The reducing agent may be selected from the group consisting of hydrazine monohydrate (H₂NNH₂.H₂O); compounds containing hydrazine monohydrate (H₂NNH₂.H₂O); and organic alkaline compounds represented by R—NHₙ wherein R is a C_{1˜20} alkyl or alkoxy group, and n is an integer of from 0 to 3. Hydrazine monohydrate (H₂NNH₂.H₂O), or a mixture of an alkylamine and an alkoxydamine is preferably used.

Upon reduction of the metal ions into the corresponding metal, the particle diameter and the shape of the metal can be controlled by a reduction rate, which is determined according to the kind of solvents, pH, temperature and the like. The reduction is commonly conducted at a temperature of −70°˜100° C., and preferably—50˜0° C. When the temperature is lower than −50° C., reduction tends not to take place. On the other hand, when the temperature is higher than 0° C., the reduction rate is so high that desired sized metal nanoparticles cannot be manufactured. The reduction is commonly carried out at a pH of 4˜14, and preferably 4˜7. When the pH is lower than 4, reduction does not tend to take place. On the other hand, when the pH is higher than 7, the reduction rate is too high.

Meanwhile, appropriate adjustment of the content of any one of silicon compounds S-1˜S-4 of Formula 1 or a derivative thereof enables the control of the size, size distribution and agglomeration of final metal nanoparticles. The stoichiometric equivalence ratio of the silicon compound or a derivative thereof to the metal ions is preferably in the range of 0.5:1˜5:1. When the silicon oxide is used in an amount exceeding this range, the layer thickness of the silicon oxide adsorbed on the metal surface is large and thus inherent electromagnetic properties of the metal are deteriorated. On the other hand, when the silicon oxide is used in an amount smaller than the defined range, particle growth arises due to the agglomeration of primary particles formed upon reduction, and thus metal nanoparticles having the desired size cannot be manufactured.

In step d), the metal nanoparticles manufactured from step c) are lyophilized. Since the metal nanoparticles are in a wet state, the lyophilization between −-70° C. and 50° C. leads to pure monodisperse nanometer-scale metal powder. The monodisperse nanometer-scale metal powder has uniform particle size distribution, superior electromagnetic properties and easy secondary dispersion.

In order to accomplish the objects of the present invention, there is provided a method for manufacturing metal nanoparticles whose surfaces are coated with a silicon oxide, comprising the steps of:

a) hydrolyzing any one of silicon compounds S-1˜S-4 of Formula 1 above or a derivative thereof;

b) mixing the hydrolysate with metal ions, and adding a solvent and an additive for forming metal complex ions thereto;

c) adding a reducing agent to reduce the metal ions into the corresponding metal; and

d) lyophilizing the resulting product of step c) at a temperature between −70° C. and 50° C.

Since the ultrafine metal nanoparticles are manufactured by adsorbing a silicon oxide on the metal surface to a thickness as small as possible, they retain inherent electromagnetic, optical and medical properties of the metal, unlike conventional metal nanoparticles manufactured using linear organic molecules, block copolymers, organic polymer compounds and silane coupling agents. At this time, the silicon oxide is obtained from any one of silicon compounds S-1˜S-4 of Formula 1 or a derivative thereof as a precursor.

The metal nanoparticles having uniform size distribution can be used as materials for electromagnetic, optical and medical functional devices, e.g., electrical devices such as monoelectron transistors, memory devices using the monoelectron transistors, transistors using resonance tunneling, electromagnetic wave shields of transparent conductive layers used in flat Braun tubes, electrodes for LCDs and PDPs and multilayer ceramic capacitors; medical devices such as antibiotic replacements using potential antibacterial properties; and optical devices such as non-linear optical materials, UV filters, fluorescence indicators and indicators for electron microscopes.

### BRIEF DESCRIPTION THE DRAWINGS

The above and other objects, features and other advantages of the present invention will be more clearly understood from the following detailed description taken in conjunction with the accompanying drawings, in which:

FIG. 1 is a transmission electron microscope (TEM) image of silver nanoparticles manufactured in Example 1 of the present invention, and a histogram showing the size distribution of the silver nanoparticles; and

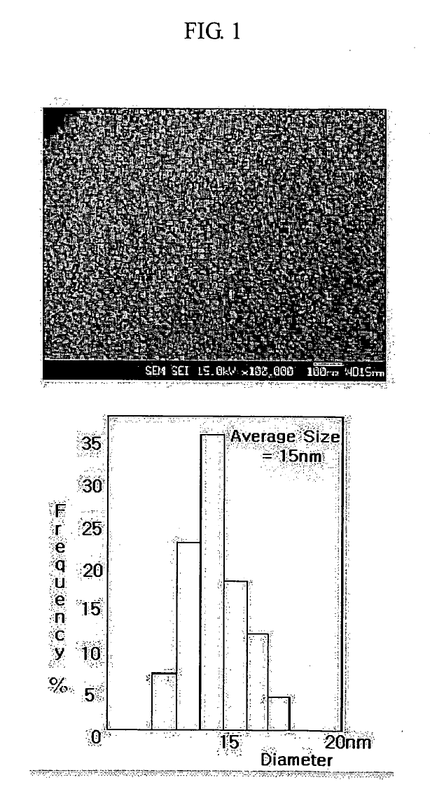

FIG. 2 is a transmission electron microscope (TEM) image of gold nanoparticles manufactured in Example 1 of the present invention, and a histogram showing the size distribution of the gold nanoparticles.

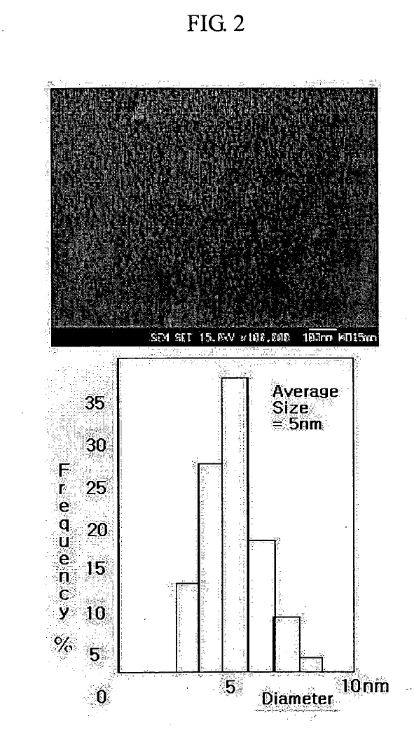

### BEST MODE FOR CARRYING OUT THE INVENTION

### EXAMPLE 1

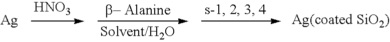

Referring to the reaction scheme above, 100 ml (0.1 moles) of 1 M Ag solution, 100 ml of distilled water and 20 g (1.22 moles) of β-alanine were mixed and dissolved. To the solution were added 400 ml of methanol, 200 ml of ethoxyethanol and 200 ml of diethylene glycol. After the resulting mixture was stirred until it was completely clear, a silicon compound or a derivative thereof was added to the solution and stirred to obtain a clear solution. After completion of the hydrolysis of the silicon compound or a derivative thereof, 10 g of triethanolamine and 100 g of ammonia water were sequentially added to form a complex compound. To the solution was added 100 ml (2.0 moles) of hydrazine monohydrate (H₂NNH₂.H₂O) to reduce the Ag particles.

The reduced Ag particles were filtered, and washed with 300 ml of distilled water six times, 300 ml of a solution of ethanol and distilled water (1:1 (v/v)) three times and 300 ml of ethanol to completely remove impurities present in the reduced Ag particles. The Ag cake in a wet state was lyophilized at a temperature of −70˜50° C. to manufacture pure monodisperse ultrafine Ag particles. The monodisperse ultrafine Ag particles have a uniform particle size distribution, superior electromagnetic properties, and easy second dispersibility.

### EXAMPLE 2

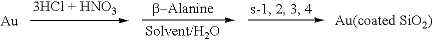

Referring to the reaction scheme above, 100 ml (0.1 moles) of 1 M Au solution, 100 ml of distilled water and 20 g (1.22 moles) of β-alanine were mixed and dissolved. To the solution were added 400 ml of methanol, 200 ml of ethoxyethanol and 200 ml of diethylene glycol. After the resulting mixture was stirred until it was completely clear, a silicon compound or a derivative thereof was added to the solution and stirred to obtain a clear solution. After completion of the hydrolysis of the silicon compound or a derivative thereof, 10 g of triethanolamine and 100 of ammonia water were sequentially added to form a complex compound. To the solution was added 100 (2.0 moles) of hydrazine monohydrate (H₂NNH₂.H₂O) to reduce the Au particles.

The reduced Au particles were filtered, and washed with 300 ml of distilled water six times, 300 ml of a solution of ethanol and distilled water (1:1 (v/v)) three times and 300 ml of ethanol to completely remove impurities present in the reduced Au particles. The Au cake in a wet state was lyophilized at a temperature of −70˜50° C. to manufacture pure monodisperse ultrafine Au particles. The monodisperse ultrafine Au particles have a uniform particle size distribution, superior electromagnetic properties, and easy secondary dispersion.

### INDUSTRIAL APPLICABILITY

As apparent from the above description, since the surfaces of the metal nanoparticles of the present invention are coated with a silicon oxide obtained from a silicon compound or a derivative thereof as a precursor, the size of the metal nanoparticles can be stably controlled and superior electromagnetic properties inherent to the metal can be maintained. In addition, since the method for manufacturing the metal nanoparticle of the present invention is similar to conventional organic synthetic methods in terms of the used devices and manners, it can be performed in a simple manner. Furthermore, the method of the present invention is advantageous over conventional methods in terms of high yield and improved physical properties of metal nanoparticles.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A metal nanoparticle whose surface is coated with a silicon oxide wherein the silicon oxide is obtained from any one of silicon compounds S-1˜S-4 represented by Formula 1 below: 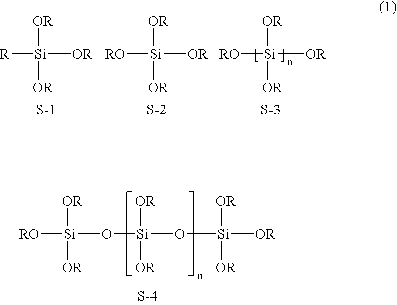
wherein
R is selected from hydrogen, C_{1˜20} alkyl, C_{6˜24} aryl, C_{1˜20} alkylated-hydroxyl, C_{1˜20} alkyoxy, C_{1˜20} alkenyl, vinyl, acryl and amino groups; and n is an integer of from 1 to 1,000,
or a derivative thereof as a precursor.

2. The metal nanoparticle according to claim 1, wherein R is a C_{1˜5} alkyl or an alkoxy group, and n is an integer of from 1 to 100.

3. The metal nanoparticle according to claim 1, wherein the metal is selected from the group consisting of gold, silver, platinum, palladium and ruthenium.

4. A method for manufacturing stabilized metal nanoparticles, comprising the steps of:
a) mixing metal ions, a solvent and an additive for forming metal complex ions;
b) adding any one of silicon compounds S-1˜S-4 represented Formula 1 below: 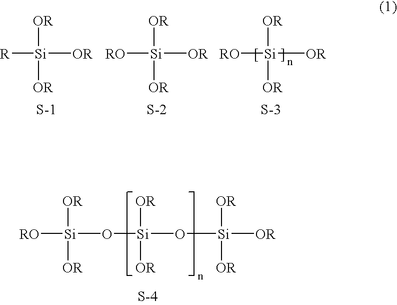
wherein
R is selected from hydrogen, C_{1˜20} alkyl, C_{6˜24} aryl, C_{1˜20} alkylated hydroxyl, C_{1˜20} alkyoxy, C_{1˜20} alkenyl, vinyl, acryl and amino groups; and n is an integer of from 1 to 1,000, or a derivative thereof, to the mixture of step a) to coat the surface of the metal ions; and
c) adding a reducing agent to the mixture of step b) to reduce the metal ions.

5. The method according to claim 4, wherein, in step a), the metal ions are obtained by dissolving the corresponding metal in an acid selected from the group consisting of aqua regia, nitric acid, hydrochloric acid and sulfuric acid.

6. The method according to claim 4, wherein, in step a), the solvent is a mixture of an alcohol, a glycol and water.

7. The method according to claim 4, wherein, in step a), the additive is selected from the group consisting of ammonia water, β-alanine and triethanolamine.

8. The method according to claim 4, wherein, in step c), the reducing agent is selected from the group consisting of hydrazine monohydrate (H₂NNH₂.H₂O); compounds containing hydrazine monohydrate (H₂NNH₂.H₂O); and organic alkaline compounds represented by R—NHₙ wherein R is a C_{1˜20} alkyl or alkoxy group, and n is an integer of from 0 to 3.

9. The method according to claim 8, wherein, in step c), the reducing agent is hydrazine monohydrate (H₂NNH₂.H₂O), or a mixture of an alkylamine and an alkoxydamine.

10. The method according to claim 4, wherein the stoichiometric equivalence ratio of the silicon compound or a derivative thereof to the metal ions is in the range of 0.5:1˜5:1.

11. The method according to claim 4, wherein, in step c), the reduction is carried out at a temperature of −70˜100° C. to control the particle size and the size distribution of the metal nanoparticles.

12. The method according to claim 11, wherein the temperature is between −50 and 0° C.

13. The method according to claim 4, wherein, in step c), the reduction is carried out at a pH of 4˜14 to control the particle size and the size distribution of the metal nanoparticles.

14. The method according to claim 13, wherein, in step c), the pH is between 4 and 7.

15. A method for manufacturing metal nanoparticles, comprising the steps of:
a) mixing metal ions, a solvent and an additive for forming metal complex ions; mixing metal ions, a solvent and an additive for forming metal complex ions;
b) adding any one of silicon compounds S-1˜S-4 represented Formula 1 below: 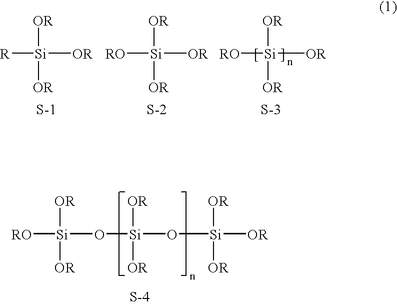
wherein
R is selected from hydrogen, C_{1˜20} alkyl, C_{6˜24} aryl, C_{1˜20} alkylated hydroxyl, C_{1˜20} alkyoxy, C_{1˜20} alkenyl, vinyl, acryl and amino groups; and n is an integer of from 1 to 1,000, or a derivative thereof, to the mixture of step a) to coat the surface of the metal ions;
c) adding a reducing agent to the mixture of step b) to reduce the metal ions; and
d) lyophilizing the resulting product of step c).

16. The method according to claim 15, wherein, in step d), the lyophilization is carried out between −70° C. and 50° C.

17. A method for manufacturing metal nanoparticles, comprising the steps of:
a) hydrolyzing any one of silicon compounds S-1˜S-4 represented by Formula 1 below: 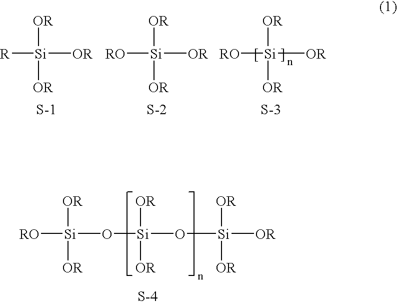
wherein
R is selected from hydrogen, C_{1˜20} alkyl, C_{6˜24} aryl, C_{1˜20} alkylated hydroxyl, C_{1˜20} alkyoxy, C_{1˜20} alkenyl, vinyl, acryl and amino groups; and n is an integer of from 1 to 1,000, or a derivative thereof;
b) mixing the hydrolysate with metal ions, and adding a solvent and an additive for forming metal complex ions thereto;
c) adding a reducing agent to reduce the metal ions into the corresponding metal; and
d) lyophilizing the resulting product of step c) at a temperature between −70° C. and 50° C.

18. An electromagnetic, optical or medical functional device using the metal nanoparticle according to claim 1.
